(19) United States
(12) Patent Application Publication
(10) Pub. No.: US 2015/0070266 A1
(43) Pub. Date: Mar. 12, 2015

(54) Gesture determination method and electronic device thereof

(71) Applicant: NOVATEK Microelectronics Corp., Hsin-Chu (TW)

(72) Inventor: Cheng-Kuang Sun, Hsinchu City (TW)

(73) Assignee: NOVATEK Microelectronics Corp., Hsin-Chu (TW)

(21) Appl. No.: 14/101,353

(22) Filed: Dec. 10, 2013

(30) Foreign Application Priority Data
Sep. 9, 2013 (TW) 102132468

(51) Int. Cl. G06F 3/01

(52) U.S. Cl. CPC G06F 3/017
USPC 345/156

(57) ABSTRACT

A gesture determination method is utilized for an electronic device. The gesture determination method includes executing a program, determining a gesture content supported by the program to obtain a supporting gesture content, detecting and determining ambient light intensity around the electronic device to generate a light intensity determination result, deciding a first sensing process or a second sensing process to perform sensing and determining a gesture for operating the program according to the operating gesture content and the light intensity determination result.

### BACKGROUND OF THE INVENTION

1. Field of the Invention

The present invention relates to a gesture determination and an electronic device, and more particularly, to a gesture determination and an electronic device capable of utilizing sensing processes with different characteristics to sense and determine gestures.

2. Description of the Prior Art

To operate an electronic device, such as a smart phone or a smart television, by gestures has gradually become one of the necessary functionalities of the electronic device for a user. Methods of operating the electronic devices by the gestures may be roughly divided to a contacting gesture operation or a non-contacting gesture operation. In the contacting gesture operation, the user is required to perform the gestures on a screen of the electronic device to operate the electronic device. In the non-contacting gesture operation, instead of touching the screen of the electronic device, the user only directly waves hands or stretches fingers to perform the gestures and then the user may remotely operate the electronic device by the gestures. In comparison with the contacting gesture operation, the non-contacting gesture operation is more convenient.

In general, technologies to implement the non-contacting gesture operation are various. In the prior art, an infrared ray sensor may be configured in the electronic device to transmit an infrared ray to the fingers of the user performing the gestures, and then the infrared ray sensor of the electronic device senses the infrared ray reflected from the fingers similarly to analyze and determine the gestures, so as to perform operations corresponding to the gestures.

However, when the electronic device performs sensing and determining the gestures in different operating environments, a gesture determination result corresponding to the gestures may be wrong in the prior art due to light intensity, temperature, or humidity conditions in the different operating environments. For example, when the infrared sensor is operated in an environment with high infrared ray intensity (such as in a room with strong sunlight or strong incandescent light), an infrared ray sensing result generated by the infrared sensor may be wrong, or even the infrared sensor may not work due to the extremely high infrared ray intensity, so as to cause the gesture determination result to be wrong. Therefore, there is a need for improvement of the prior art.

### SUMMARY OF THE INVENTION

It is therefore an objective of the present invention to provide a gesture determination and an electronic device capable of utilizing sensing processes with different characteristics to sense and determine gestures, so as to improve accuracy of a gestures determination result.

The present invention discloses a gesture determination method for an electronic device. The gesture determination method comprises executing a program; determining a gesture content supported by the program to obtain a supporting gesture content; detecting and determining ambient light intensity around the electronic device to generate a light intensity determination result; and deciding a first sensing process or a second sensing process to perform sensing and determining a gesture for operating the program according to the supporting gesture content and the light intensity determination result.

The present invention further discloses an electronic device. The electronic device comprises a first sensing module for sensing a gesture; a second sensing module for sensing a gesture; an ambient light sensing module for detecting ambient light intensity around the electronic device; and a processor module, coupled to the first sensing module, the second sensing module, and the ambient light sensing module. The processor module comprises a processor; and a storage device, storing a program code to indicate to the processor to perform a method. The method comprises executing a program; determining a gesture content supported by the program to obtain a supporting gesture content; detecting and determining ambient light intensity around the electronic device to generate a light intensity determination result; and deciding a first sensing process or a second sensing process to perform sensing and determining a gesture for operating the program according to the supporting gesture content and the light intensity determination result; wherein the first sensing process and the second sensing process control the first sensing module and the second sensing module to sense the gesture for determining the gesture.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an electronic device according to an embodiment of the present invention.

FIG. 2 is a schematic diagram of a gesture determination process according to an embodiment of the present invention.

FIG. 3 is a schematic diagram of a sensing process determination process according to an embodiment of the present invention.

FIG. 4 is a schematic diagram of a waking-up process according to an embodiment of the present invention.

### DETAILED DESCRIPTION

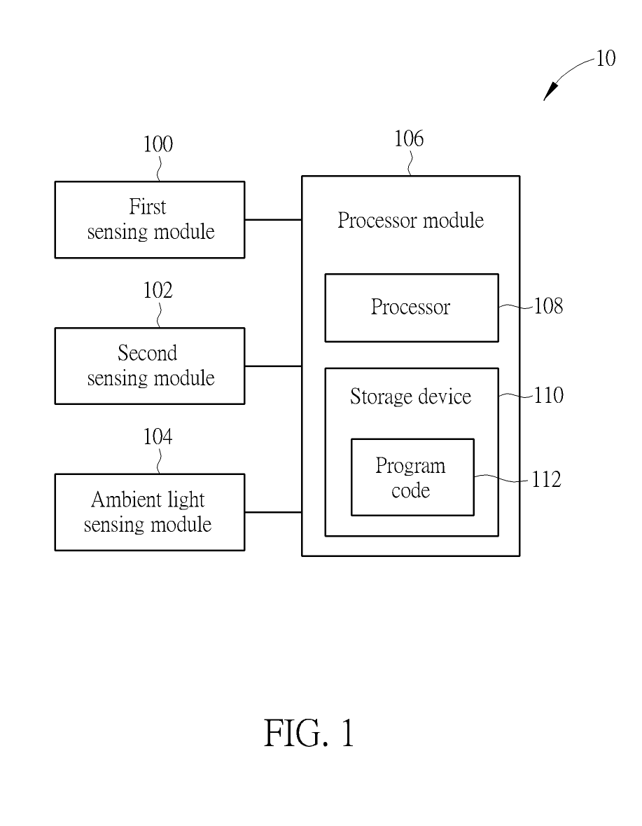

FIG. 1 is a schematic diagram of an electronic device 10 according to an embodiment of the present invention. As shown in FIG. 1, the electronic device 10 includes a first sensing module 100, a second sensing module 102, an ambient light sensing module 104 and a processor module 106. The processor module 106 is coupled with the first sensing module 100, the second sensing module 102, and the ambient light sensing module 104. The processor module 106 controls the first sensing module 100, the second sensing module 102, and the ambient light sensing module 104 to perform sensing. Then, the processor module 106 may receive signals corresponding to sensing results generated by the first sensing module 100, the second sensing module 102 and the ambient light sensing module 104 to perform determining.

The electronic device 10 may be a tablet, a smart television, or a smart phone, etc. The electronic device 10 senses a gesture performed by a user waving hands or scratching fingers, and then the electronic device 10 determines the gesture to perform a corresponding operation. Under such a situation, the user may control the electronic device 10 without touching the electronic device 10. In general, the gesture may be a moving gesture performed by the user moving the fingers, a scaling gesture performed by the user holding and releasing the fingers, a pushing gesture performed by the user moving the fingers to the electronic device 10, or a pulling gesture performed by the user moving the fingers away from the electronic device 10, etc. For example, when the electronic device 10 is the smart television, the user may control the electronic device 10 to turn a television from one channel to another by the moving gesture, to adjust volume by the scaling gesture, to start by the pushing gesture, or to shut down by the pulling gesture, etc.

In addition, the user may also utilize other complex gestures, such as a gesture performed by the user sequentially pointing, pushing, or moving the fingers, to interact with the electronic device 10 through a display component to perform browsing the internet or other more complex operations, which may make modifications accordingly and is not limited hereinafter. Under such a situation, the user may control the electronic device 10 by the gesture to perform the corresponding operation without touching a screen or a button of the electronic device 10.

In detail, the first sensing module 100 may be an infrared ray sensing module. When the user performs the gesture by the fingers in front of the electronic device 10, the first sensing module 100 utilizes an infrared ray light emitter diode to transmit an infrared ray to the fingers, and simultaneously the first sensing module 100 further utilizes an infrared ray sensor to sense the infrared ray reflected from the fingers. Thereby, the first sensing module 100 may convert the sensed infrared ray to signals to transmit to the processor module 106. The processor module 106 analyzes the signals to determine the gestures for controlling the electronic device 10 to perform the corresponding operations. In addition, the first sensing module 100 may also utilize an infrared ray filter to filter unwanted light from outside, and then only the light having a frequency around the frequency of the infrared ray may be allowed to transmit into the infrared ray sensor, such that the infrared ray sensor may properly sense the infrared ray reflected by the fingers.

The second sensing module 102 may be a camera sensing module. When the user performs the gesture with the fingers in front of the electronic device 10, the second sensing module 100 utilizes a camera to capture the images corresponding to the gesture performed by the user. Thereby, the second sensing module 102 transmits the captured images to the processor module 106, and the processor module 106 may analyze the image to determine the gesture for controlling the electronic device 10 to perform the corresponding operations. In addition, the second sensing module 102 may also utilize a visible light filter to filter unwanted light from outside, and then only the light having a frequency around the frequency of the visible light may be allowed to transmit into the camera, such that the camera may clearly capture the images of the gesture.

The ambient light sensing module 104 comprises an ambient light sensor for detecting ambient light intensity around the electronic device 10 to generate a light intensity value to transmit to the processor module 106. Furthermore, since human vision has the most sensitivity in a green light having a wavelength of 555.016 nm, the ambient light sensing module 104 may also utilize a green light filter to filter unwanted light from outside, and only the light having a frequency around the frequency of the green light may be allowed to transmit into the ambient light sensor, such that the ambient light sensor may accurately detect the ambient light intensity. Notably, the ambient light sensing module 104 may also utilize a red light filter or a blue light filter to filter and then detect the ambient light intensity, which are not limited hereinafter.

The processor module 106 includes a processor 108 and a storage device 110. The processor 108 may be a microprocessor or an application-specific integrated circuit (ASIC). The storage device 110 may be a data storage device with any type. For example, the storage device 110 may be a read-only memory (ROM), a random-access memory (RAM), a CD-ROM, a magnetic tape, a floppy disk, an optical data storage device, or etc, which is not limited hereinafter. Additionally, a program code 112 is stored in the storage device 110 to indicate to the processor 108 to control the first sensing module 100, the second sensing module 102, and the ambient light sensing module 104 to sense the gesture, and to receive the signals transmitted from the first sensing module 100, the second sensing module 102, and the ambient light sensing module 104 to perform a gesture determination process.

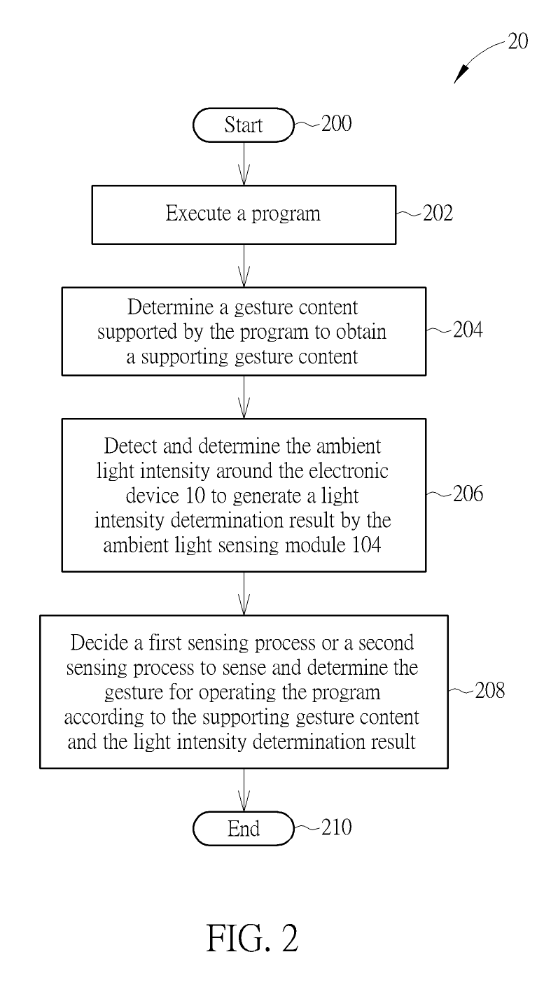

Under such a condition, since the electronic device 10 includes the first sensing module 100 and the second sensing module 102, the processor module 106 may separately control the first sensing module 100 and the second sensing module 102 to perform corresponding sensing processes with different characteristics, and the processor module 106 may select a proper sensing process among the sensing processes to sense and determine the gesture. Specifically, please refer to FIG. 2, which is a schematic diagram of a gesture determination process according to an embodiment of the present invention. In the embodiment, the gesture determination process 20 is performed in the processor module 106 in FIG. 1 and may be compiled as the program code 112 stored in the storage device 110 to control the processor 108 to perform the gesture determination process 20. As shown in FIG. 2, the gesture determination process 20 includes the following steps:

Step 200: start.

Step 202: execute a program.

Step 204: determine a gesture content supported by the program to obtain a supporting gesture content.

Step 206: detect and determine the ambient light intensity around the electronic device 10 to generate a light intensity determination result by the ambient light sensing module 104.

Step 208: decide a first sensing process or a second sensing process to sense and determine the gesture for operating the program according to the supporting gesture content and the light intensity determination result.

Step 210: end.

According to the gesture determination process 20, the processor module 106 controls the first sensing module 100 and the second sensing module 102 to perform the first sensing process and the second sensing process to sense the gestures. Then, the processor module 106 may receive the signals or the images respectively converted by the first sensing module 100 and the second sensing module 102 to analyze and determine the gesture.

In detail, in steps 202-204, when the user executes the program in the electronic device 10, the processor module 106 starts to execute the program. Then, the processor module 106 further determines the gesture content supported by the program to obtain the supporting gesture content. The supporting gesture content may include a moving gesture, a scaling gesture, a pushing gesture, or a pulling gesture, etc. Only when the user performs the gestures included in the supporting gesture content to operate the program, then the program may properly receive the gesture to perform the corresponding operations. For example, when the electronic device 10 is the smart phone, after the user executes an address book program, the user may move an address list in the address book program up or down by the moving gesture supported by the address book program to browser phone number data in the address list. Moreover, the user may also perform a calling operation for current browsing phone number by the pushing gesture supported by the address book program to call a user corresponding to the current browsing phone number. Thereby, since the gesture contents supported by the address book program are previously designed by program designers, after the processor module 106 executes the address book program, the processor module 106 may determine the gesture contents supported by the address book program to obtain the supporting gesture content.

Notably, the processor module 106 may further obtain information of the supporting gesture content by other characteristics of the program, such as a type of the program or a usage of the program. For example, when the program executed by the user is a video play program or a picture capture program, the processor module 106 determines that the program is only required to perform the playing or capturing operation, and then the processor module 106 may obtain the information of the supporting gesture content as a gesture content including simple gesture operations. On the other hands, when the program executed by the user is a notebook program or an Internet browser program, the processor module 106 determines that the program is required to perform the pointing, clicking, or dragging operation, and then the processor module 106 may obtain the information of the supporting gesture content as a gesture content including complex gesture operations.

Additionally, when the program executed by the user is designed for the user to operate by the gesture within a short distance, the processor module 106 determines the program is operated by the gesture within a short distance according to the program usage to obtain the information of the supporting gesture content as a gesture content including short distance gesture operations. For example, when the user executes a presentation program and presents a presentation in front of the smart television by the gesture, the processor module 106 determines the presentation program is operated by the gesture within a short distance according to the usage of the presentation program to obtain the information of the supporting gesture content corresponding to the presentation program as a gesture content including short distance gesture operations. On the other hand, when the program executed by the user is designed for the user to operate by the gesture within a long distance, the processor module 106 may similarly obtain the information of the supporting gesture content as a gesture content including long distance gesture operations. The information of the supporting gesture content may be alternated according to actual requirements and is not limited hereinafter.

In step 206, the processor module 106 starts to notify the ambient light sensing module 104 to detect the ambient light intensity around the electronic device 10. Then, the processor module 106 receives the light intensity value corresponding to the ambient light intensity generated by the ambient light sensing module 104 to perform determination. The processor module 106 determines whether the light intensity value is less than a light intensity setting value. When the processor module 106 determines that the light intensity value is less than the light intensity setting value, the processor module 106 generates a light intensity determination result to indicate the ambient light intensity around the electronic device is low. When the processor module 106 determines that the light intensity value is not less than the light intensity setting value, the processor module 106 generates the light intensity determination result to indicate the ambient light intensity around the electronic device is high.

In addition, in order to generate the light intensity determination result to be more stable and not to be arbitrarily changed, the processor module 106 further detects the ambient light intensity around the electronic device 10 at a first time point, and then the processor module 106 receives the light intensity value generated by the ambient light sensing module 104 to generate a first light intensity value. Next, the processor module 106 detects the ambient light intensity around the electronic device 10 at a second time point, and the processor module 106 receives the light intensity value generated by the ambient light sensing module 104 to generate a second light intensity value. Notably, the time interval between the first time point and the second time point may be adjusted according to the actual requirements and is not limited hereinafter.

After the processor module 106 obtains the first light intensity value and the second light intensity value, the processor module 106 calculates an absolute difference between the first light intensity value and the second light intensity value to obtain a light intensity absolute difference value. The light intensity absolute difference value represents the variation of the ambient light intensity between the first time point and the second time point. Furthermore, for ensuring the light intensity determination result not to be arbitrarily changed, only when the light intensity absolute difference value is greater than a light intensity range value, the processor module 106 may control the ambient light sensing module 104 to detect the ambient light intensity around the electronic device 10, and the processor module 106 receives the light intensity value generated by the ambient light sensing module 104 to perform determination to generate the light intensity determination result. That is, when the processor module 106 determines that the light intensity value is less than the light intensity setting value, the processor module 106 generates the light intensity determination result to indicate the ambient light intensity around the electronic device is low. When the processor module 106 determines that the light intensity value is not less than the light intensity setting value, the processor module 106 generates the light intensity determination result to indicate the ambient light intensity around the electronic device is high. Notably, the light intensity range value may be modified according to the environments or the detected light intensity value, which is not limited to a fixed value.

In step 208, the processor module 106 inquiries the first sensing module 100 and determines a gesture content capable of being sensed by the first sensing module 100 to obtain a sensing gesture content. For example, when a sensing resolution of the infrared ray sensor in the first sensing module 100 is small and the first sensing module 100 may only sense the reflected infrared ray with large area, the processor module 106 may inquiry the first sensing module 100 to obtain information of the infrared ray sensor and determine the gesture content capable of being sensed by the first sensing module 100 to obtain the sensing gesture content. Since the sensing resolution of the infrared ray sensor is small, the processor module 106 determines the sensing gesture content includes simple gesture operations, such as the moving gesture or the scaling gesture. Furthermore, the processor module 106 may also determine the sensing gesture content includes short distance gestures operation.

After the processor module 106 obtains the sensing gesture content, the processor module 106 determines whether the sensing gesture content includes the supporting gesture content to generate the sensing determination result. The sensing determination result may indicate whether to perform the first sensing process to control the first sensing module 100 to sense and determine the gesture. Notably, the sensing resolution of the infrared ray sensor in the first sensing module 100 is smaller than the capturing resolution of the camera in the second sensing module 102, that is, the gesture content capable of being sensed by the first sensing module 100 is more limited. Thus, the processor module 106 first determines whether the sensing gesture content of the first sensing module 100 includes the supporting gesture content to decide whether to perform the first sensing process to control the first sensing module 100 to sense and determine the gesture. When the sensing gesture content of the first sensing module 100 includes the supporting gesture content, the processor module 106 generate the sensing determination result to indicate to sense the gesture by the first sensing process, and then the processor module 106 may control the first sensing module 100 to sense and determine the gesture. On the other hands, when the sensing gesture content of the first sensing module 100 does not include the supporting gesture content, the processor module 106 generates the sensing determination result to indicate not to sense the gesture by the first sensing process.

As a result, when the light intensity determination result indicates the ambient light intensity around the electronic device 10 is high, since the second sensing module 102 captures the images corresponding to the gesture by the camera for the gesture determination, the gesture is suitable to be captured by the second sensing module 102 in the environment with highlight intensity, and the processor module 106 performs the second sensing process to control the second sensing module 102 to sense and determine the gesture. When the light intensity determination result indicates the ambient light intensity around the electronic device is low, since the first sensing module 100 senses the infrared ray corresponding to the gesture by the infrared ray sensor, the gesture is suitable to be sensed by the first sensing module 100 in the environment with low light intensity. At this moment, the processor module 106 further determines whether the sensing determination result indicates to sense the gesture by the first sensing process. When the sensing determination result indicates to sense the gesture by the first sensing process, the processor module 106 performs the first sensing process to control the first sensing module 100 to sense and determine the gesture. Notably, when the light intensity determination result indicates the ambient light intensity is low and the sensing determination result indicates not to sense the gesture by the first sensing process, the processor module 106 does not determine the gesture. Then, the processor module 106 displays a message to notify the user by the display component, such as a monitor.

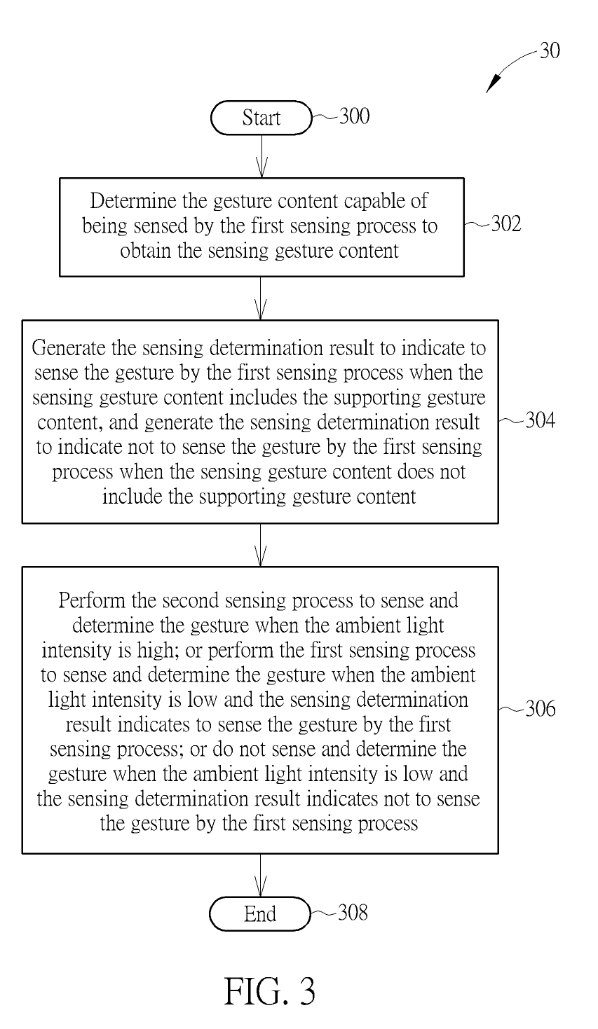

The operations of the processor module 208 deciding the first sensing process or the second sensing process to determine the gesture according to the supporting gesture content and the light intensity determination result may be further summarized as a sensing process determination process 30. In the embodiment, the sensing process determination process 30 is also performed in the processor module 106 in FIG. 1 and may be compiled as the program code 112. The program code 112 is stored in the storage device 110 to control the processor 108 to perform the sensing process determination process 30. FIG. 3 is a schematic diagram of the sensing process determination process 30 according to an embodiment of the present invention, and the sensing process determination process 30 includes the following steps:

Step 300: start.

Step 302: determine the gesture content capable of being sensed by the first sensing process to obtain the sensing gesture content.

Step 304: generate the sensing determination result to indicate to sense the gesture by the first sensing process when the sensing gesture content includes the supporting gesture content, and generate the sensing determination result to indicate not to sense the gesture by the first sensing process when the sensing gesture content does not include the supporting gesture content.

Step 306: perform the second sensing process to sense and determine the gesture when the light intensity determination result indicates the ambient light intensity is high; or perform the first sensing process to sense and determine the gesture when the light intensity determination result indicates the ambient light intensity is low and the sensing determination result indicates to sense the gesture by the first sensing process; or do not sense and determine the gesture when the light intensity determination result indicates the ambient light intensity is low and the sensing determination result indicates not to sense the gesture by the first sensing process.

Step 308: end.

In short, the electronic device 10 utilizes the first sensing module 100 to sense the reflected infrared ray corresponding to the gesture performed by the user by the infrared ray sensor, and the electronic device 10 may perform the first sensing process to determine the gesture. Moreover, the electronic device 10 may also utilize the second sensing module 102 to capture the images corresponding to the gesture performed by the user by the camera, and the electronic device 10 performs the second sensing process to determine the gesture. Thereby, the electronic device 10 detects the ambient light intensity around the electronic device 10 and determines the supporting gesture content of the executed program to decide a proper sensing process to sense the gesture among the first sensing module 100 and the second sensing module, which have different sensing characteristics. Under such a condition, when the user performs the gesture to operate the electronic device 10 in the environment with high light intensity, the electronic device 10 may perform the second process to control the second sensing module 102 to capture the images corresponding to the gesture for the gesture determination, such that the second sensing module 102 may properly capture the images in the environment with high light intensity to determine the gesture. Furthermore, when the user performs the gesture to operate the electronic device 10 in the environment with low light intensity, the electronic device 10 may perform the first process to control the first sensing module 102 to sense the infrared ray corresponding to the gesture for the gesture determination, such that the second sensing module 102 may properly sense the reflected infrared ray in the environment with low light intensity to determine the gesture.

Additionally, since the sensing resolutions of the infrared ray sensor in the first sensing module 100 is limited and the first sensing module 100 may not sense more complex gestures, the electronic device 10 is required to further determine whether the sensing gesture content of the first sensing module 100 includes the supporting gesture content of the program to decide whether to perform the first sensing process to control the first sensing module 100 to sense the gesture, so as to avoid generating the wrong sensing result. As a result, the electronic device 10 properly integrates the two sensing processes with different characteristics to sense and determine the gesture, and the gesture determination result may be more accurate.

On the other hands, when the user does not operate the electronic device 10 for a long period, the processor module 106 may control the electronic device 10 to operate in a sleep mode for saving power. In the sleep mode, only the circuits related to waking up the electronic device 10 are active, and other circuits may be powered down for saving power. Moreover, the first sensing module 100 utilizes the infrared ray sensor to sense the gesture, and the power consumption of the first sensing module 100 is less than the power consumption of the second sensing module 102, which utilizes the camera to sense the gesture. Thus, when the user wakes up the electronic device 10 by the gesture to continuously operate the electronic device 10, the processor module 106 may perform the first sensing process in the sleep mode to control the first sensing module 100 to sense and determine the gesture.

After the processor module 106 performs the first sensing process to sense and determine the gesture performed by the user to generate the gesture determination result, the processor module 106 compares whether the gesture determination result is complied with a start command pre-defined by the user. When the gesture determination result is complied with the start command, the processor module 106 controls the electronic device 10 to switch from the sleep mode to a normal mode. For example, the user may previously define the start command as the scaling gesture. When the user does not operate the electronic device 10 for a long period, the processor module 106 controls the electronic device 10 to operate in the sleep mode for saving power. Under such a situation, when the user performs the scaling gesture in front of the electronic device 10, the processor module 106 utilizes the first sensing module 100 to sense and determine the gesture to generate the gesture determination result. Then, when the processor module 106 determines the gesture determination result is complied with the scaling gesture, the processor module 106 controls the electronic device 10 to switch from the sleep mode to the normal mode, and then the user may continuously operate the electronic device 10.

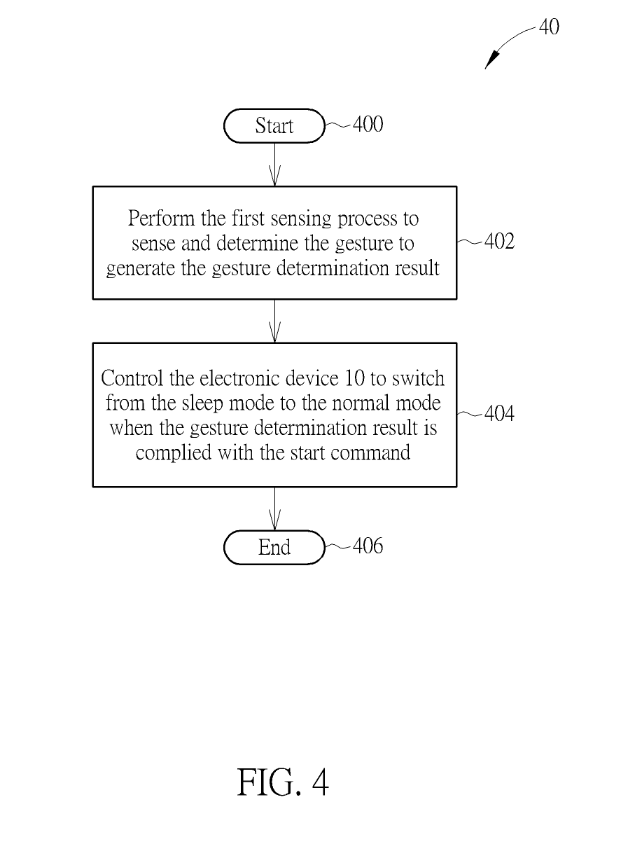

The operations of the processor module 106 switching from the sleep mode to the normal mode maybe further summarized as a waking-up process 40. In the embodiment, the waking-up process 40 is performed by the processor module 106 in FIG. 1 and may be compiled as the program code 112, which is stored in the storage device 110 to control the processor 108 to perform the waking-up process 40. As shown in FIG.4, the waking-up process 40 includes the following steps:

Step 400: start.

Step 402: perform the first sensing process to sense and determine the gesture to generate the gesture determination result.

Step 404: control the electronic device 10 to switch from the sleep mode to the normal mode when the gesture determination result is complied with the start command.

Step 406: end.

In short, the user previously defines the start command as a special gesture, and the user may wake up the electronic device 10 by the gesture to continuously operate the electronic device 10, for example to watch the smart television or to operate the smart phone. The electronic device 10 selects one process, which has lower power consumption and is easier for performing, among the two sensing modules with different characteristics, Then, the user may rapidly wake up the electronic device 10 and the electronic device 10 may also spent less power to continuously perform the operations for detecting the waking-up gesture in the sleep mode.

Specifically, in the present invention, the electronic device 10 integrates the sensing modules with different sensing characteristics, and the electronic device 10 decides a proper sensing module among the sensing modules to perform a corresponding sensing process according to the ambient light intensity around the electronic device 10 and the requirement of the executed program to sense and determine the gesture of the user, so as to improve the accuracy of the gesture determination result. Those skilled in the art can make modifications or alterations accordingly. For example, in the embodiment, the first sensing module 100 is the infrared ray sensing module and the second sensing module 102 is the camera sensing module. One of the two sensing modules is decided to sense the gesture according to the light intensity of the environment. In other embodiments, the first sensing module 100 may also be an ultrasound sensing module and the second sensing module 102 is still the camera sensing module. One of the two sensing modules may be decided to sense the gesture according to the light intensity, the temperature, the humidity or the sound volume of the environment. The methods of integrating two or more sensing modules with different characteristics and deciding the proper sensing module to sense and determine the gesture are all adapted to the present invention.

Furthermore, in the embodiment, the processor module 106 obtains the sensing gesture content and determines whether the sensing gesture content includes the supporting gesture content to generate the sensing determination result to indicate whether to perform the first sensing process to control the first sensing module 100 to sense and determine the gesture. In another embodiment, the processor module 106 may also obtain the information of the sensing gesture content, which may be a gesture content including simple gesture operations or a gesture content including complex gesture operations, and then the processor module 106 determines whether the information of the sensing gesture content is complied with the information of the supporting gesture content to generate the sensing determination result to indicate whether to perform the first sensing process to control the first sensing module 100 to sense and determine the gesture. In addition, the processor module 106 may also obtain the information of the sensing gesture content, which may be a gesture content including short distance gesture operations or a gesture content including long distance gesture operations, and then the processor module 106 determines whether the information of the sensing gesture content is complied with the information of the supporting gesture content to generate the sensing determination result to indicate whether to perform the first sensing process to control the first sensing module 100 to sense and determine the gesture. The information of the supporting gesture content and the sensing gesture content may be modified according to the actual requirements and is not limited hereinafter.

Furthermore, in the embodiment, two sensing modules with different characteristics are utilized for describing that the electronic device 10 may decide the proper sensing module to perform the corresponding process to sense and determine the gesture of the user according to the operating environment of the electronic device 10. However, in other embodiments, the electronic device 10 may also configure three, four, or more sensing modules with different characteristics, and the electronic device 10 decides the proper sensing module to perform the corresponding process to sense and determine the gesture of the user according to the operating environment of the electronic device 10.

In summary, the prior art senses and determines the gesture only by a single sensing technology, and the gesture determination result may be wrong due to the different operating environments. In comparison, the present invention integrates the sensing processes with different characteristics and decides the proper sensing process to sense and determine the gesture according to the light intensity of the environments and the requirements of the operating program. Thus, the gesture determination result may be more accurate.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A gesture determination method for an electronic device, the gesture determination method comprising:
executing a program;
determining a gesture content supported by the program to obtain a supporting gesture content;
detecting and determining ambient light intensity around the electronic device to generate alight intensity determination result; and
deciding a first sensing process or a second sensing process to perform sensing and determining a gesture for operating the program according to the supporting gesture content and the light intensity determination result.

2. The gesture determination method of claim 1, wherein the first sensing process comprises:
transmitting an infrared ray to an object performing the gesture; and
sensing the infrared ray reflected from the object to perform sensing and determining the gesture.

3. The gesture determination method of claim 1, wherein the second sensing process comprises:
capturing an image corresponding to the gesture to perform sensing and determining the gesture.

4. The gesture determination method of claim 1, wherein the step of detecting and determining the ambient light intensity around the electronic device to generate the light intensity determination result comprises:
detecting the ambient light intensity around the electronic device to generate a light intensity value; and
generating the light intensity determination result to indicate the ambient light intensity around the electronic device is low when determining that the light intensity value is less than an light intensity setting value, and generating the light intensity determination result to indicate the ambient light intensity around the electronic device is high when determining that the light intensity value is greater than the light intensity setting value.

5. The gesture determination method of claim 1, wherein the step of detecting and determining the ambient light intensity around the electronic device to generate the light intensity determination result further comprises:
at a first time point, detecting the ambient light intensity around the electronic device to generate a first light intensity value;
at a second time point, detecting the ambient light intensity around the electronic device to generate a second light intensity value;
calculating an absolute difference value between the first light intensity value and the second light intensity value to obtain a light intensity absolute difference value;
detecting the ambient light intensity around the electronic device to generate a light intensity value when the light intensity absolute difference value is greater than a light intensity range value; and
generating the light intensity determination result to indicate the ambient light intensity around the electronic device is low when determining that the light intensity value is less than a light intensity setting value, and generating the light intensity determination result to indicate the ambient light intensity around the electronic device is high when determining that the light intensity value is greater than the light intensity setting value.

6. The gesture determination method of claim 1, wherein the step of deciding the first sensing process or the second sensing process to perform sensing and determining the gesture for operating the program according to the supporting gesture content and the light intensity determination result comprises:
determining a gesture content capable of being sensed by the first sensing process to obtain a sensing gesture content;
generating a sensing determination result to indicate to sense the gesture by the first sensing process when the sensing gesture content comprises the supporting gesture content, and generating the sensing determination result to indicate not to sense the gesture by the first sensing process when the sensing gesture content does not comprise the supporting gesture content; and
deciding the first sensing process or the second sensing process to perform sensing and determining the gesture for operating the program according to the sensing determination result and the light intensity determination result.

7. The gesture determination method of claim 6, wherein the supporting gesture content and the sensing gesture content respectively comprise a moving gesture, a scaling gesture, a pushing gesture, and a pulling gesture.

8. The gesture determination method of claim 6, wherein the step of deciding the first sensing process or the second sensing process to perform sensing and determining the gesture for operating the program according to the sensing determination result and the light intensity determination result comprises:
performing the second sensing process to sense and determine the gesture when the light intensity determination result indicates the ambient light intensity around the electronic device is high; or
performing the first sensing process to sense and determine the gesture when the light intensity determination result indicates the ambient light intensity around the electronic device is low and the sensing determination result indicates to sense the gesture by the first sensing process; or
not sensing and determining the gesture when the light intensity determination result indicates the ambient light intensity around the electronic device is low and the sensing determination result indicates not to sense the gesture by the first sensing process.

9. The gesture determination method of claim 8, wherein the step of not sensing and determining the gesture comprises:
displaying a message to notify a user performing the gesture when not sensing and determining the gesture.

10. The gesture determination method of claim 1 further comprising:
controlling the electronic device to operate in a sleep mode;
performing the first sensing process to sense and determine the gesture to generate a gesture determination result; and
controlling the electronic device whether to continuously operate in the sleep mode according to the gesture determination result.

11. The gesture determination method of claim 10, wherein the step of controlling the electronic device whether to continuously operate in the sleep mode according to the gesture determination result comprises:
controlling the electronic device to switch from the sleep mode to a normal mode when determining that the gesture determination result is complied with a start command.

12. An electronic device comprising:
a first sensing module for sensing a gesture;
a second sensing module for sensing a gesture;
an ambient light sensing module for detecting ambient light intensity around the electronic device; and
a processor module, coupled to the first sensing module, the second sensing module, and the ambient light sensing module, the processor module comprising:
a processor; and
a storage device, storing a program code to indicate to the processor to perform a method, the method comprising:
executing a program;
determining a gesture content supported by the program to obtain a supporting gesture content;
detecting and determining ambient light intensity around the electronic device to generate a light intensity determination result; and
deciding a first sensing process or a second sensing process to perform sensing and determining a gesture for operating the program according to the supporting gesture content and the light intensity determination result;
wherein the first sensing process and the second sensing process control the first sensing module and the second sensing module to sense the gesture for determining the gesture.

13. The electronic device of claim 12, wherein the first sensing module is an infrared ray sensing module and the first sensing process controls the infrared ray sensing module to transmit an infrared ray to an object performing the gesture and sense the infrared ray reflected from the object to perform sensing and determining the gesture.

14. The electronic device of claim 12, wherein the second sensing module is a camera sensing module and the second sensing process controls the camera sensing module to capture an image corresponding to the gesture to perform sensing and determining the gesture.

15. The electronic device of claim 12, wherein the step of detecting and determining the ambient light intensity around the electronic device to generate the light intensity determination result comprises:
detecting the ambient light intensity around the electronic device to generate a light intensity value; and
generating the light intensity determination result to indicate the ambient light intensity around the electronic device is low when determining that the light intensity value is less than a light intensity setting value, and generating the light intensity determination result to indicate the ambient light intensity around the electronic device is high when determining that the light intensity value is greater than the light intensity setting value.

16. The electronic device of claim 12, wherein the step of detecting and determining the ambient light intensity around the electronic device to generate the light intensity determination result further comprises:
at a first time point, detecting the ambient light intensity around the electronic device to generate a first light intensity value;
at a second time point, detecting the ambient light intensity around the electronic device to generate a second light intensity value;
calculating an absolute difference value between the first light intensity value and the second light intensity value to obtain a light intensity absolute difference value;
detecting the ambient light intensity around the electronic device to generate a light intensity value when the light intensity absolute difference value is greater than a light intensity range value; and
generating the light intensity determination result to indicate the ambient light intensity around the electronic device is low when determining that the light intensity value is less than an light intensity setting value, and generating the light intensity determination result to indicate the ambient light intensity around the electronic device is high when determining that the light intensity value is greater than the light intensity setting value.

17. The electronic device of claim 12, wherein the step of deciding the first sensing process or the second sensing process to perform sensing and determining the gesture for operating the program according to the supporting gesture content and the light intensity determination result comprises:
determining a gesture content capable of being sensed by the first sensing process to obtain a sensing gesture content;
generating a sensing determination result to indicate to sense the gesture by the first sensing process when the sensing gesture content comprises the supporting gesture content, and generating the sensing determination result to indicate not to sense the gesture by the first sensing process when the sensing gesture content does not comprise the supporting gesture content; and
deciding the first sensing process or the second sensing process to perform sensing and determining the gesture for operating the program according to the sensing determination result and the light intensity determination result.

18. The electronic device of claim 17, wherein the supporting gesture content and the sensing gesture content respectively comprise a moving gesture, a scaling gesture, a pushing gesture, and a pulling gesture.

19. The electronic device of claim 17, wherein the step of deciding the first sensing process or the second sensing process to perform sensing and determining the gesture for operating the program according to the sensing determination result and the light intensity determination result comprises:
performing the second sensing process to sense and determine the gesture when the light intensity determination result indicates the ambient light intensity around the electronic device is high; or
performing the first sensing process to sense and determine the gesture when the light intensity determination result indicates the ambient light intensity around the electronic device is low and the sensing determination result indicates to sense the gesture by the first sensing process; or
not sensing and determining the gesture when the light intensity determination result indicates the ambient light intensity around the electronic device is low and the sensing determination result indicates not to sense the gesture by the first sensing process.

20. The electronic device of claim 19, wherein the step of not sensing and determining the gesture comprises:
displaying a message to notify a user performing the gesture when not sensing and determining the gesture.

21. The electronic device of claim 12, wherein the method further comprises:
controlling the electronic device to operate in a sleep mode;
performing the first sensing process to sense and determine the gesture to generate a gesture determination result; and
controlling the electronic device whether to continuously operate in the sleep mode according to the gesture determination result.

22. The electronic device of claim 21, wherein the step of controlling the electronic device whether to continuously operate in the sleep mode according to the gesture determination result comprises:
controlling the electronic device to switch from the sleep mode to a normal mode when determining that the gesture determination result is complied with a start command.
